(19) United States
(12) Patent Application Publication
(10) Pub. No.: US 2015/0022554 A1
(43) Pub. Date: Jan. 22, 2015

(54) IMAGE DISPLAY DEVICE AND IMAGE DISPLAY METHOD

(71) Applicant: SEIKO EPSON CORPORATION, Tokyo (JP)

(72) Inventor: Tatsuhiko NOBORI, Matsumoto-Shi (JP)

(21) Appl. No.: 14/325,979

(22) Filed: Jul. 8, 2014

(30) Foreign Application Priority Data
Jul. 19, 2013 (JP) 2013-150214

(51) Int. Cl. G09G 5/377

(52) U.S. Cl. CPC G09G 5/377
USPC 345/634

(57) ABSTRACT

An image display device includes a combining section adapted to generate a composite image obtained by combining an OSD image with a first region of an input image, a setting section adapted to set a third region in the composite image based on the first region and a second region set at a predetermined position, a calculation section adapted to calculate a feature amount related to a luminance in the third region, and an expansion section adapted to expand a grayscale range of the luminance of the composite image based on the feature amount. The setting section sets the third region so as to include the first region and the second region in a case in which the combining section combines the OSD image, and in the case in which at least a part of the first region is located outside the second region.

The entire disclosure of Japanese Patent Application No. 2013-150214, filed Jul. 19, 2013, is expressly incorporated by reference herein.

### BACKGROUND

1. Technical Field

The present invention relates to an image display device and an image display method.

2. Related Art

As a configuration of a display device for displaying an image such as a content, there has been known a projector, which modulates light emitted from a light source in accordance with an image signal using a light modulation device (e.g., a liquid crystal light valve), and then projects the modulated light on a screen or the like in an enlarged manner to display the image. The light modulation device is provided with a plurality of pixels, and controls the transmittance of the light pixel by pixel in accordance with the grayscale information represented by the image signal to thereby form the image corresponding to the image signal.

In recent years, there has been proposed a projector provided with an expansion device for correcting the grayscale (the transmittance) of each of the pixels in order to expand the effective grayscale range, and a dimming device capable of roughly evenly reducing the intensity of the light entering each of the pixels of the light modulation device in accordance with the correction. According to this configuration, it becomes possible to increase the number of the effective grayscales (expand the dynamic range) to improve the contrast feel by performing an adaptive dimming process, namely reduction of the light intensity by the dimming device and the expansion of the grayscale range by the expansion device, when displaying, for example, a dark image.

In such a projector, in the case in which the adaptive dimming process fails to follow up the change in the image, the deterioration (e.g., the highlight detail loss and the blocked up shadows) of the image is apt to occur. For example, in a sudden transition from a dark scene to a bright scene, the adaptive dimming process fails to follow up the luminance change, and performs an excessive expansion suitable for the dark scene to cause the highlight detail loss. In contrast, if the expansion and the dimming are performed so as to follow the luminance of the image changed successively, although it becomes possible to suppress the highlight detail loss or the like, there is a problem of flicker in the screen.

As the technology for inhibiting the image generated due to the adaptive dimming process from deteriorating as described above, there has been proposed a projector for extracting the feature amount with respect to the luminance of the image, and performing the expansion process corresponding to the position and the range where the deterioration occurs based on the feature amount as described in JP-A-2007-47244 (Document 1). On this occasion, since the central portion of the image is closely observed by the observer compared to the peripheral portion of the image, and for removing the influence of a black bar, subtitles, and so on caused by the aspect ratio of the content displayed, weighting is performed in the central portion of the image to suppress the deterioration of the image.

Incidentally, many projectors are provided with an on-screen display (hereinafter referred to as “OSD”) function for the user to operate the projector to call the menu screen of the function setting, and perform the setting instruction in the state in which the menu screen is superimposed on the image in the case in which a variety of function settings need to be performed while displaying the image using the projector. Such an OSD image such as the menu screen is configured so as to be displayed in the peripheral portion of the image taking the visibility of the image currently displayed into consideration.

However, in the expansion process described in Document 1, since the feature amount is extracted while weighting the central portion of the image, the luminance of the OSD image disposed in the peripheral portion of the image is difficult to be reflected. Therefore, in the case in which the central portion of the image is dark, there is a problem that the OSD image disposed in the periphery portion of the image is deteriorated due to the highlight detail loss.

### SUMMARY

An advantage of some aspects of the invention is to suppress the deterioration of the image to be projected including the OSD image.

The invention can be implemented as the following forms or application examples.

### Application Example 1

An image display device according to this application example includes a combining section adapted to generate a composite image obtained by combining an OSD image with a first region of an input image, a setting section adapted to set a third region in the composite image based on the first region and a second region set at a predetermined position, a calculation section adapted to calculate a feature amount related to a luminance in the third region, and an expansion section adapted to expand a grayscale range of the luminance of the composite image based on the feature amount, and the setting section sets the second region as the third region in a case in which the combining section does not combine the OSD image, and sets the third region so as to include the first region and the second region in a case in which the combining section combines the OSD image, and in the case in which at least a part of the first region is located outside the second region.

According to such a configuration, the second region is set as the third region in the case in which the OSD image is not combined with the input image, the first region and the second region are set as the third region in the case in which the OSD image is combined with the input image, and in the case in which at least a part of the first region for displaying the OSD image overlaps the second region set at a predetermined position in the composite image obtained by combining the OSD image with the input image, and the feature amount related to the luminance is calculated in the third region, and then the grayscale range of the luminance of the composite image is expanded based on the feature amount thus calculated. Therefore, in the case of combining the OSD image with the input image, since the feature amount related to the luminance is calculated with respect to the region including the OSD image, the grayscale range of the luminance can appropriately be expanded with respect to the composite image including the OSD image.

### Application Example 2

In the image display device according to the application example described above, it is preferable that the setting section sets a plurality of regions including the first region and the second region as the third region in a case in which the first region and the second region do not overlap each other.

According to such a configuration, even in the case in which the first region and the second region do not overlap each other, the feature amount can be calculated with respect to the plurality of regions including the OSD image.

### Application Example 3

In the image display device according to the application example described above, it is preferable that there are further included a dimming control section adapted to control the luminance of the composite image having been expanded based on the feature amount calculated by the calculation section, and a display section adapted to display the composite image with the luminance controlled by the dimming control section.

According to such a configuration, the composite image including the OSD image can be displayed on the display section with the luminance appropriately controlled.

### Application Example 4

In the image display device according to the application example described above, it is possible that the first region and the second region each have a rectangular shape, and the setting section sets one rectangular region including the first region and the second region as the third region.

### Application Example 5

In the image display device according to the application example described above, it is possible that the setting section sets an entire area of the composite image as the third region in the case in which the combining section combines the OSD image, and in the case in which at least a part of the first region is located outside the second region.

### Application Example 6

An image display device according to this application example includes a calculation section adapted to calculate a feature amount related to a luminance in a predetermined region of an input image, an expansion section adapted to perform an expansion process of expanding a grayscale range of the luminance of the input image based on the feature amount, and a combining section adapted to combine an OSD image with the input image, and the expansion section stops the expansion process in a case in which the combining section combines the OSD image.

### Application Example 7

In the image display device according to the application example described above, it is possible that the combining section combines the OSD image with a first region of the input image, the calculation section calculates the feature amount in a second region of the input image, and the expansion section stops the expansion process in a case in which the combining section combines the OSD image, and in the case in which at least a part of the first region is located outside the second region.

### Application Example 8

An image display method according to this application example includes: generating a composite image obtained by combining an OSD image with a first region of an input image, setting a third region in the composite image based on the first region and a second region set at a predetermined position, calculating a feature amount related to a luminance in the third region, and expanding a grayscale range of the luminance of the composite image based on the feature amount, and in the setting, the second region is set as the third region in a case in which the OSD image is not combined in the generating, and the third region is set so as to include the first region and the second region in a case in which the OSD image is combined in the generating, and in the case in which at least a part of the first region is located outside the second region.

According to such a method, the second region is set as the third region in the case in which the OSD image is not combined with the input image, the first region and the second region are set as the third region in the case in which the OSD image is combined with the input image, and in the case in which at least a part of the first region for displaying the OSD image overlaps the second region set at a predetermined position in the composite image obtained by combining the OSD image with the input image, and the feature amount related to the luminance is calculated in the third region, and then the grayscale range of the luminance of the composite image is expanded based on the feature amount thus calculated. Therefore, in the case of combining the OSD image with the input image, since the feature amount related to the luminance is calculated with respect to the region including the OSD image, the grayscale range of the luminance can appropriately be expanded with respect to the composite image including the OSD image.

### BRIEF DESCRIPTION OF THE DRAWINGS

The invention will be described with reference to the accompanying drawings, wherein like numbers reference like elements.

FIG. 1 is a configuration diagram showing a schematic configuration of a projector according to an embodiment of the invention.

FIG. 2 is a block diagram showing a functional configuration of the projector according to the embodiment of the invention.

FIG. 3A is a diagram for explaining an overlap relationship of two regions, and FIG. 3B is a diagram showing a configuration example of a measurement region.

FIG. 4 is an explanatory diagram showing an example of input grid points of an expansion coefficient.

FIG. 5 is a flowchart showing a flow of a process for setting the measurement region.

FIG. 6 is a diagram showing a configuration example of the measurement region in the case in which the two regions are not superimposed.

FIG. 7 is a diagram showing a configuration example of the measurement region in the case in which one is included in the other.

### DESCRIPTION OF AN EXEMPLARY EMBODIMENT

An embodiment of the invention will hereinafter be explained with reference to the accompanying drawings.

### Embodiment

Hereinafter, the projector for modulating the light emitted from the light source in accordance with the image signal to display the image by projecting the modulated light on a screen or the like in an enlarged manner will be explained as an image display device according to the embodiment of the invention.

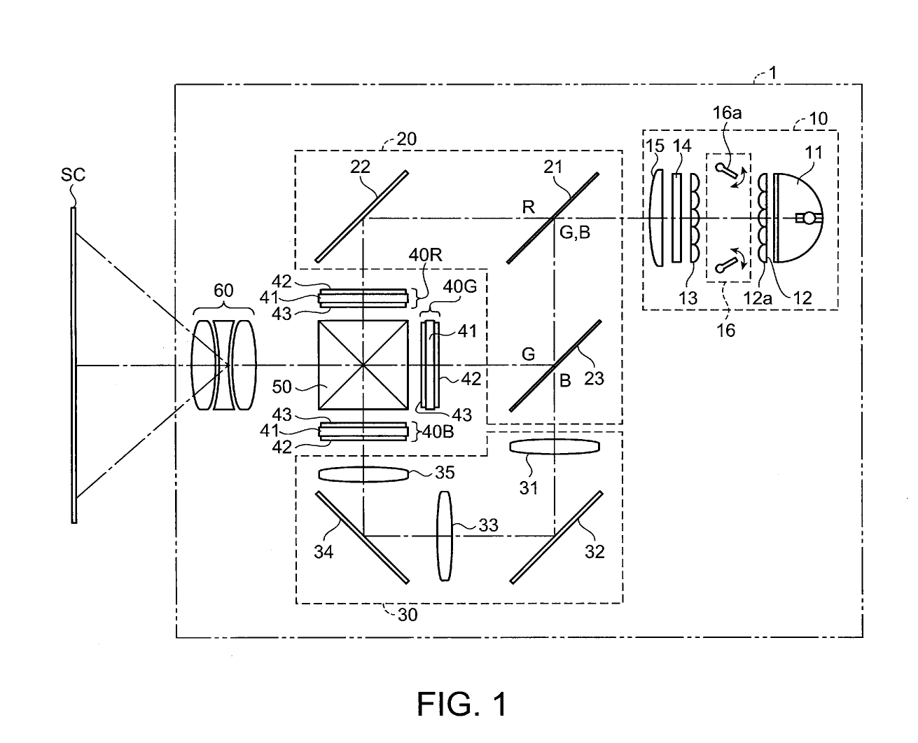

FIG. 1 is a configuration diagram showing a schematic configuration of the projector 1, and shows a light path along which the light emitted from the light source reaches the screen. As shown in FIG. 1, the projector 1 is provided with an illumination optical system 10, a color separation optical system 20, a relay optical system 30, three liquid crystal light valves 40R, 40G, and 40B as a light modulation device, a cross dichroic prism 50 as a combining optical system, and a projection lens 60 as a projection optical system.

The illumination optical system 10 is provided with a light source 11 formed of a discharge light source lamp such as a super high pressure mercury lamp or a metal halide lamp, a first lens array 12, a second lens array 13, a polarization conversion element 14, an overlapping lens 15, and a dimming element 16. The light beam emitted from the light source 11 is divided into a number of minute light beams by the first lens array 12 composed of minute lenses 12a arranged in a matrix. The second lens array 13 and the overlapping lens 15 are provided so that each of the light beams obtained by the dividing operation illuminates the entire three liquid crystal light valves 40R, 40G, and 40B as the illumination object. Therefore, the light beams are overlapped each other by the liquid crystal light valves 40R, 40G, and 40B, and the entire liquid crystal light valves 40R, 40G, and 40B are roughly evenly illuminated. It should be noted that the illumination optical system 10, and the liquid crystal light valves 40R, 40G, and 40B correspond to a display section.

Here, the light path between the first and second lens arrays 12, 13 is provided with the dimming element 16. The dimming element 16 is arranged to be able to narrow down the light emitted from the first lens array 12 due to the rotation of a louver 16a, and can block some of the light beams divided into by the first lens array 12. Therefore, the intensity of the light illuminating the liquid crystal light valves 40R, 40G, and 40B is roughly evenly limited in accordance with the amount of narrowing down of the dimming element 16.

The polarization conversion element 14 has a function of uniformizing the light from the light source 11 into polarized light having a specific polarization direction in order to make it possible to efficiently use the light from the light source 11 in the liquid crystal light valves 40R, 40G, and 40B. The polarized light emitted from the illumination optical system 10 enters the color separation optical system 20.

The color separation optical system 20 is provided with a first dichroic mirror 21, a first reflecting mirror 22, and a second dichroic mirror 23, and divides the light emitted from the illumination optical system 10 into three colors of light different in wavelength band from each other. The first dichroic mirror 21 transmits roughly red light, and reflects light having a wavelength shorter than the wavelength of the light thus transmitted. The red light R transmitted through the first dichroic mirror 21 is reflected by the first reflecting mirror 22 to illuminate the liquid crystal light valve 40R for the red light.

Among the light reflected by the first dichroic mirror 21, the green light G is reflected by the second dichroic mirror 23 to illuminate the liquid crystal light valve 40G for the green light. Further, the blue light B is transmitted through the second dichroic mirror 23, passes through the relay optical system 30 to illuminate the liquid crystal light valve 40B for the blue light.

It should be noted that since the path of the blue light B becomes longer than the paths of other colored light beams, in order to inhibit the efficiency of the illumination of the liquid crystal light valve 40B from deteriorating due to the diffusion of the light beam, the relay optical system 30 is disposed on the path of the blue light B. The relay optical system 30 is provided with an entrance side lens 31, a second reflecting mirror 32, a relay lens 33, a third reflecting mirror 34, and an exit side lens 35. The blue light B emitted from the color separation optical system 20 is converged by the entrance side lens 31 in the vicinity of the relay lens 33, and is diffused toward the exit side lens 35.

Each of the liquid crystal light valves 40R, 40G, and 40B is provided with a liquid crystal panel having a liquid crystal encapsulated between a pair of transparent substrates, and on the inside surface of the liquid crystal panel 41, there are formed transparent electrodes (pixel electrodes) in a matrix, which are capable of applying a drive voltage to the liquid crystal in every microscopic area (pixel). On the entrance side and the exit side of the liquid crystal panel 41, there are disposed an entrance side polarization plate 42 and an exit side polarization plate 43, respectively. Each of the entrance side polarization plate 42 and the exit side polarization plate 43 can transmit only the polarized light with a specific polarization direction, and the entrance side polarization plate 42 is arranged to be able to transmit the polarized light with the polarization direction uniformized by the polarization conversion element 14. Therefore, large proportions of the colored light beams respectively entering the liquid crystal light valves 40R, 40G, and 40B enter the liquid crystal panels 41 through the entrance side polarization plates 42. It should be noted that the liquid crystal light valves 40R, 40G, and 40B are each provided with a drive circuit (not shown) for driving the liquid crystal panel 41 based on the image signal to be input.

Here, if the drive voltage corresponding to the image signal is applied to each of the pixels of the liquid crystal panel 41, the light entering the liquid crystal panel 41 is modulated in accordance with the drive voltage, and becomes the polarized light different in polarization direction between the pixels. In the polarized light, only the polarized component capable of passing through the exit side polarization plate 43 is emitted from each of the liquid crystal light valves 40R, 40G, and 40B. In other words, the liquid crystal light valves 40R, 40G, and 40B each transmit the incident light with the transmittance different by pixel in accordance with the image signal to thereby form the image light having gradation for each of the colored light beams. The image light formed of the colored light beams emitted from the liquid crystal light valves 40R, 40G, and 40B enters the cross dichroic prism 50.

The cross dichroic prism 50 combines the image light beams of the respective colors emitted from the liquid crystal light valves 40R, 40G, and 40B pixel by pixel to form the image light representing the color image. The image light combined by the cross dichroic prism 50 is projected on the screen SC by the projection lens 60 in an enlarged manner, and is displayed as the image.

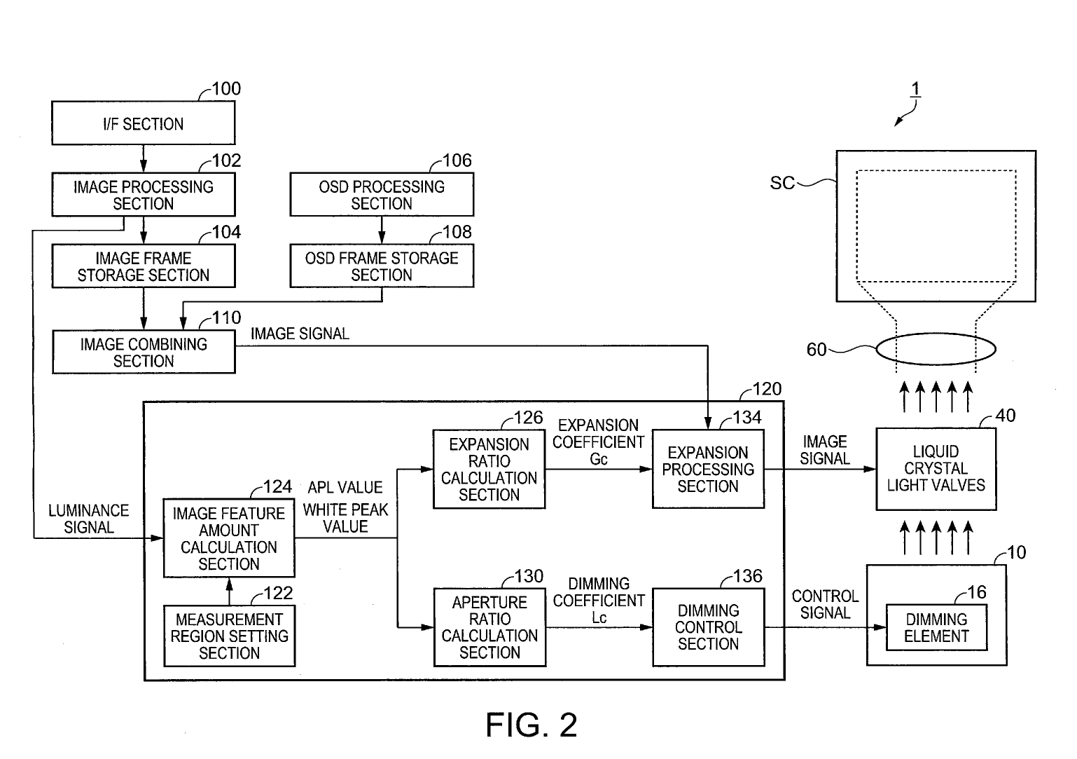

FIG. 2 is a block diagram showing a functional configuration of the projector 1. This projector 1 is provided with an I/F section 100, an image processing section 102, an image frame storage section 104, an OSD processing section 106, an OSD frame storage section 108, an image combining section 110, and a dimming processing section 120.

Further, the dimming processing section 120 has a function of performing the expansion process of the luminance and the dimming control based on the luminance information of the image signal, and is provided with a measurement region setting section 122, an image feature amount calculation section 124, an expansion ratio calculation section 126, an aperture ratio calculation section 130, an expansion processing section 134, and a dimming control section 136.

It should be noted that the projector 1 has hardware such as a CPU, a ROM, a RAM, a flash memory, and so on all not shown, and the functions of the functional sections described above are realized by the hardware and software stored in the ROM and so on in cooperation with each other.

The I/F section 100 receives a variety of types of content images as an input image input from the outside such as a DVD reproduction device or the Internet, converts the image data of the content images thus received into a predetermined internal format, and then outputs the image data having been converted into the predetermined internal format to the image processing section 102. It should be noted that although in the present embodiment, there is assumed the configuration in which the content image to be input to the I/F section 100 is a moving image, a configuration of a still image can also be assumed.

The image processing section 102 performs a resizing process based on the image data of the content image input from the I/F section 100, and at the same time, generates the content image signal expressing each of the grayscales of R (red), G (green), and B (blue) with a 10-bit luminance value (0 through 1023), and a luminance signal Y. It should be noted that the luminance signal Y is formed of a 10-bit luminance value representing the luminance when combining the colors, and can be calculated as the following formula: Y=0.299R+0.578G+0.144B (R, G, and B are the luminance value of the respective colors). Alternatively, it is possible to use the maximum value of either one of R, G, and B as the luminance signal Y. The content image signal thus generated is stored in the image frame storage section 104 frame by frame. Further, the luminance signal Y is output to the image feature amount calculation section 124.

Further, the OSD processing section 106 generates an OSD image including a menu called by the user, a warning message to be announced to the user, and so on, and then stores the OSD image signal thus generated in the OSD frame storage section 108 frame by frame.

In the case of performing the OSD display, the image combining section 110 performs a combining process on the content image signal of each frame stored in the image frame storage section 104 and the OSD image signal stored in the OSD frame storage section 108 so that the content image and the OSD image are displayed in combination with each other, and then outputs a composite image signal obtained by the combining process to the expansion processing section 134. Further, in the case in which the OSD display is not performed, the image combining section 110 outputs the content image signal of each frame stored in the image frame storage section 104 to the expansion processing section 134. The image combining section 110 corresponds to a combining section.

Then, the functional sections of the dimming processing section 120 will be explained.

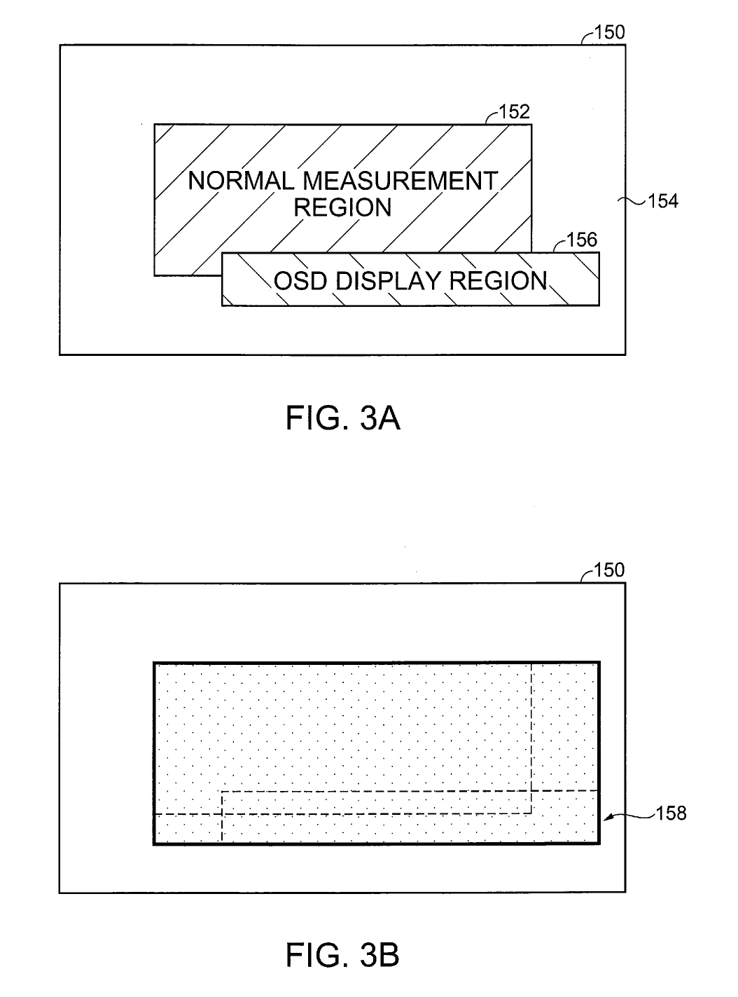

The measurement region setting section 122 sets the region (hereinafter referred to as a measurement region) to be an object for calculating the image feature amount with respect to the frame. The measurement region setting section 122 corresponds to a setting section. Here, FIGS. 3A and 3B are diagrams showing a configuration example of the measurement region 158 corresponding to a third region, wherein FIG. 3A explains an overlap relationship between two regions, and FIG. 3B shows the configuration example of the measurement region.

As shown in FIG. 3A, a normal measurement region 152 for calculating the image feature amount is determined in advance with respect to a frame region 150 as the processing object. The normal measurement region 152 corresponds to a second region, and is set at a predetermined position. In the present embodiment, the normal measurement region 152 is a region set in roughly central portion of the frame region 150 weighted compared to the peripheral portion 154 so as to suppress the influence of the black bar generated due to the difference in aspect ratio by the content, subtitles, and so on.

Further, in the case of performing the OSD display, the OSD image is configured to be displayed in an OSD display region 156 in a normal state. The OSD display region 156 corresponds to a first region. In the present embodiment, the information representing the sizes and the positions of the normal measurement region 152 and the OSD display region 156 is stored in the ROM and so on in advance.

The measurement region setting section 122 sets the measurement region 158 having a rectangular shape based on the normal measurement region 152 and the OSD display region 156 each having a rectangular shape. In the case in which, for example, at least a part of the OSD display region 156 is located outside the normal measurement region 152, the measurement region setting section 122 sets a rectangular region including the normal measurement region 152 and the OSD display region 156 as the measurement region 158 as shown in FIG. 3B. The measurement region 158 is a calculation object region of the image feature amount calculation section 124. It should be noted that the normal measurement region 152, the OSD display region 156, and the frame region 150 are not limited to a rectangular shape, but can be assumed to have a variety of configurations. The information of the measurement region 158 set by the measurement region setting section 122 is transmitted to the image feature amount calculation section 124.

Further, in the case in which the OSD display is not performed, the measurement region setting section 122 sets the normal measurement region 152 as the measurement region 158.

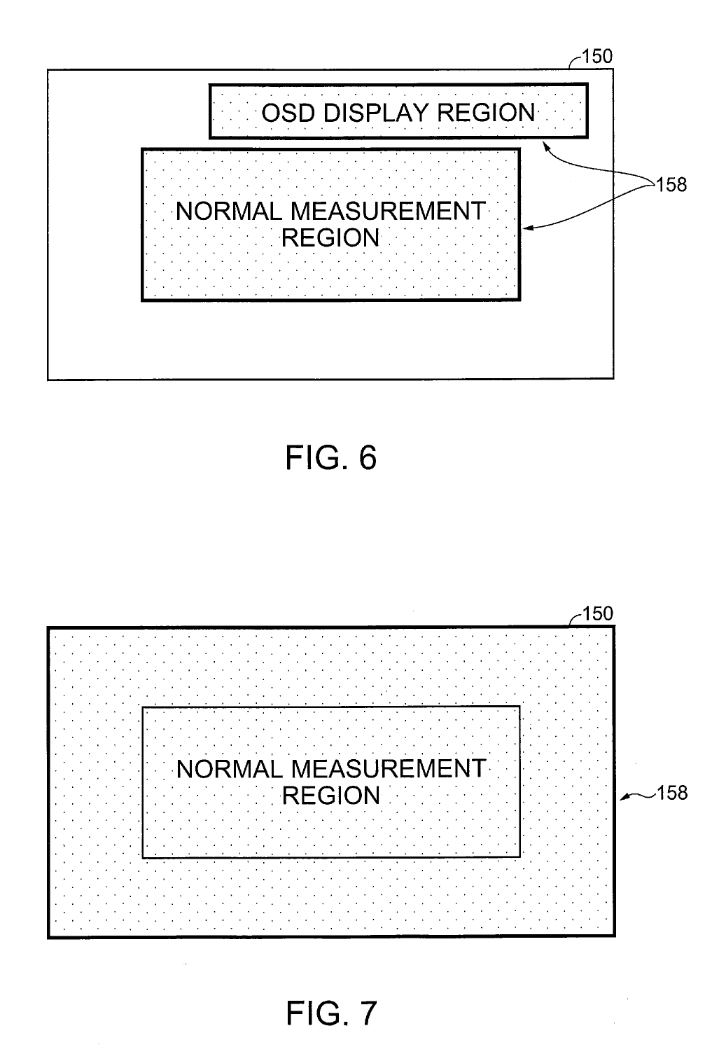

Further, in the case in which the normal measurement region 152 and the OSD display region 156 do not overlap each other, the configuration of setting each of the regions as the measurement region 158 can be assumed (see FIG. 6).

Further, in the present embodiment, the measurement region setting section 122 compares the information of the OSD display region 156 to be projected in the case of performing a keystone distortion correction for electronically correcting the trapezoidal distortion when performing the projection and the information of the OSD display region 156 stored in the ROM with each other. There is provided a function of correcting the size and the position of the OSD display region 156 to set the measurement region 158 based on the OSD display region thus corrected in the case in which the size of the OSD display region 156 and the position where the OSD display region 156 is projected run off the original OSD display region 156 due to the keystone distortion correction as a result of the comparison.

Going back to FIG. 2, the image feature amount calculation section 124 calculates an APL value and a white peak value WP based on the luminance signal Y in the measurement region 158 set by the measurement region setting section 122. The image feature amount calculation section 124 corresponds to a calculation section.

In the present embodiment, the image feature amount calculation section 124 divides the region defined by the measurement region 158 into small regions with a predetermined size (e.g., 16×16 pixels). Subsequently, the image feature amount calculation section 124 calculates an average value of the luminance of the pixels in each of the small regions, calculates an average of the average values of the luminance of the small regions thus calculated to obtain the APL value, and then sets the maximum value of the luminance of the small regions to the white peak value WP. Here, the APL value and the white peak value WP are expressed in 10 bits. The information of the APL value and the white peak value WP calculated by the image feature amount calculation section 124 is transmitted to the expansion ratio calculation section 126 and the aperture ratio calculation section 130.

The expansion ratio calculation section 126 calculates the expansion coefficient Gc representing the expansion ratio with reference to an expansion coefficient look-up table (LUT) described later using the APL value and the white peak value WP calculated by the image feature amount calculation section 124. It should be noted that the range of the value of the expansion coefficient Gc can arbitrarily be set, and is set to a range of, for example, 0 through 255.

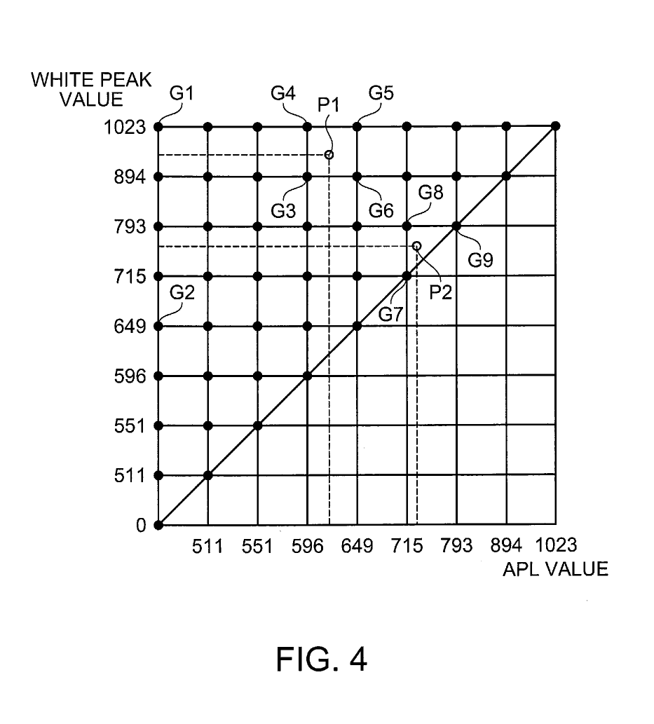

FIG. 4 is an explanatory diagram showing an example of input grid points of the expansion coefficient LUT. In FIG. 4, the horizontal axis represents the APL value, and the vertical axis represents the white peak value WP. The expansion coefficient Gc is stored in each of the input grid points indicated by filled circles shown in FIG. 4. Since the APL value never exceeds the white peak value WP, no expansion coefficient Gc is stored in the input grid points in the lower right half of the expansion coefficient LUT, and thus the reduction of the memory amount is achieved.

In the case in which a set of the APL value and the white peak value WP corresponds to any one of the input grid points (the filled circles) in FIG. 4, the expansion ratio calculation section 126 reads out and uses the expansion coefficient Gc at the input grid point without modification. In the case in which the set of the APL value and the white peak value WP does not correspond to the input grid points, for example, the case of the coordinate P1 or the coordinate P2, the expansion coefficient Gc is obtained by an interpolation calculation. For example, in the case of the coordinate P1 surrounded by the four input grid points, the expansion coefficient Gc can be calculated by appropriately performing a four-point interpolation calculation from the surrounding four input grid points G3 through G6. Further, in the case of the coordinate P2 surrounded by the three input grid points, the expansion coefficient Gc can be calculated by appropriately performing a three-point interpolation calculation from the surrounding three input grid points G7 through G9. The expansion coefficient Gc calculated by the expansion ratio calculation section 126 is transmitted to the expansion processing section 134.

Going back to FIG. 2, the expansion processing section 134 expands the grayscale range of the luminance, namely the distribution range of the luminance, of the image signal based on the expansion coefficient Gc calculated by the expansion ratio calculation section 126. It should be noted that the image signal input to the expansion processing section 134 is the composite image signal in the case of performing the OSD display, and is the content image signal in the case in which the OSD display is not performed. The expansion processing section 134 corresponds to an expansion section. This process is performed using Formulae 1a through 1d below. Here, A0, G0, and B0 are values of color information of the image signal before performing the luminance range expansion process, and R1, G1, and B1 are values of the color information of the image signal after performing the luminance range expansion process. Further, the expansion ratio K1 is obtained by Formula 1d.

R1=K1*R0 (1a)

G1=K1*G0 (1b)

B1=K1*B0 (1c)

K1=1+Gc/255 (1d)

Since the expansion coefficient Gc is equal to or greater than 0, the expansion ratio K1 is equal to or greater than 1.

Further, the expansion processing section 134 transmits the image signal, on which the expansion processing has been performed, to the liquid crystal light valves 40.

Meanwhile, the aperture ratio calculation section 130 derives the dimming coefficient Lc expressing the aperture ratio with reference to a dimming control look-up table using the APL value and the white peak value WP calculated by the image feature amount calculation section 124. It should be noted that the range of the value of the dimming coefficient Lc can arbitrarily be set, and is set to a range of, for example, 0 through 255.

It should be noted that in the present embodiment, the dimming coefficient LUT has the same configuration as that of the expansion coefficient LUT. Further, the method of determining the dimming coefficient Lc with reference to the dimming coefficient LUT is also the same as the method of determining the expansion coefficient Gc, and therefore the detailed explanation thereof will be omitted.

The dimming control section 136 obtains a light intensity ratio A1 expressed by Formula 2 below from the dimming coefficient Lc, and then controls the dimming element 16 based on the value of the light intensity ratio A1. The light intensity ratio A1 represents the ratio to the maximum light intensity, and fulfills A1≦1.

A1=Lc/255 (2)

Incidentally, if the light intensity ratio A1 and the expansion ratio K1 obtained by Formula 1d described above satisfy the relationship of Formula 3, the maximum luminance of the image on which the luminance range expansion process and the dimming control have been performed becomes the same as the maximum luminance of the image on which the luminance range expansion process and the dimming control have not been performed.

A1=K1^{-γ} (3)

Here, γ denotes the γ value of the liquid crystal light values 40, and fulfills, for example, γ=2.2.

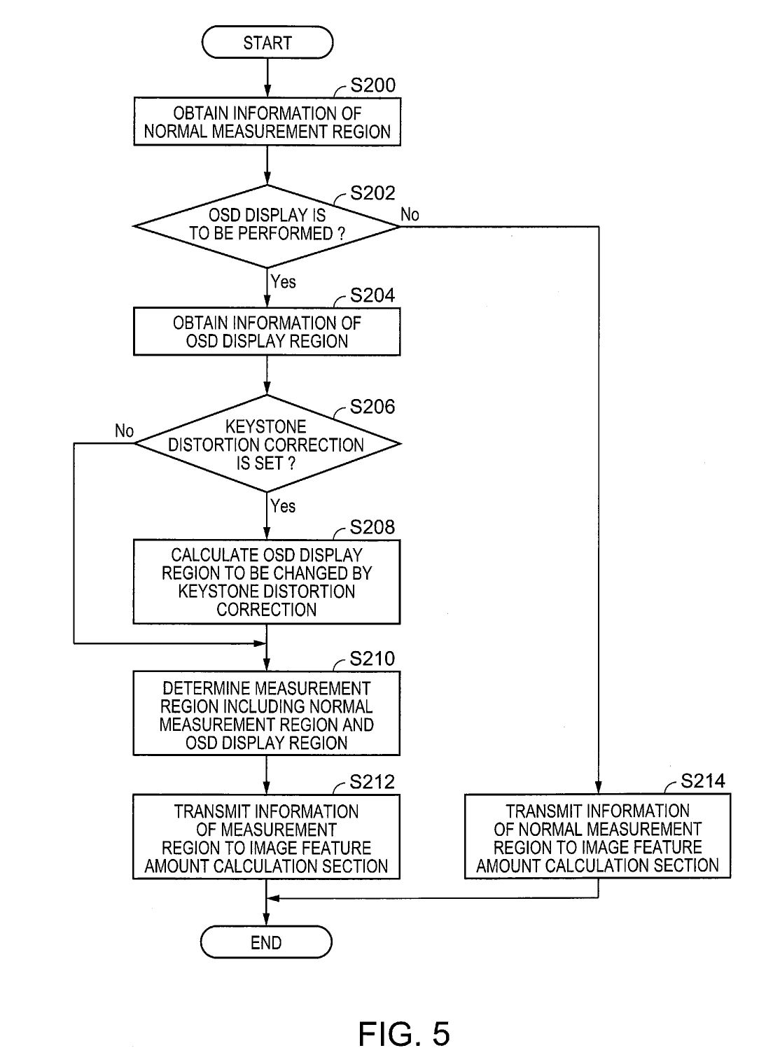

FIG. 5 is a flowchart showing a flow of a process of a setting process for setting the measurement region 158. There is assumed a configuration in which this process is stored in the ROM and so on as, for example, a measurement region setting program, and the CPU reads out and executes the program if need arises. Further, in the anterior stage of this process, a combining process for generating the composite image is performed, and in the posterior stage of this process, the calculation process and the expansion process are performed.

Firstly, the CPU obtains (step S200) the information related to the normal measurement region 152.

Subsequently, the CPU determines whether or not the OSD display is set to be performed (step S202).

Here, in the case in which it is determined that the OSD display is not set (No in the step S202), the CPU transmits (step S124) the information of the normal measurement region 152 to the processing section in the posterior stage, namely the image feature amount calculation section 124, as the information of the measurement region 158, and then the process is terminated.

On the other hand, in the case in which it is determined that the OSD display is set (Yes in the step S202), the CPU obtains (step S204) the information related to the OSD display region 156.

Subsequently, the CPU determines (step S206) whether or not the keystone distortion correction is set, and in the case in which it is determined that the keystone distortion correction is not set (No in the step S206), the process proceeds to the step S210.

On the other hand, in the case in which it is determined that the keystone distortion correction is set (Yes in the step S206), the CPU calculates (step S208) the OSD display region 156 to be changed by the keystone distortion correction, and the process proceeds to the step S210.

In the step S210, the CPU determines the measurement region 158 including the normal measurement region 152 and the OSD display region 156.

Subsequently, the CPU transmits (step S214) the information of the measurement region 158 to the image feature amount calculation section 124, and then terminates the process.

According to the embodiment described hereinabove, the following advantages can be obtained.

1. In the case of displaying the OSD image superimposed on the content image by the projector 1, since the OSD display region 156 is included in the measurement region 158 in which the feature of the luminance is extracted for expanding the grayscale of the luminance of the image, the adaptive dimming process is performed including the OSD image, therefore, it is avoided that the OSD image is deteriorated due to the highlight detail loss, and the adaptive dimming process of the content image including the OSD image can appropriately be performed.

2. Since the OSD display region 156 can appropriately be calculated even in the case in which the position and the size of the OSD image are changed due to the keystone distortion correction, the adaptive dimming process can appropriately be performed without depending on the installation state of the projector 1.

Although the invention is hereinabove explained based on the embodiment shown in the drawings, the invention is not limited to the present embodiment, but such modified examples as described below can also be assumed.

(1) In the case of determining the measurement region 158 based on whether or not the OSD display is performed, in the case of performing the OSD display as shown in FIG. 7, it is also possible to set the entire area of the frame region 150 as the measurement region 158 irrespective of the position and the size of the OSD display region 156. On the other hand, in the case in which the OSD display is not performed, the normal measurement region 152 can be set as the measurement region 158.

(2) In the case of performing the OSD display, and in the case in which at least a part of the OSD display region 156 runs off the normal measurement region 152, it is also possible to arrange that the expansion process and the dimming control by the dimming processing section 120 are substantially stopped. For example, it is sufficient that the expansion ratio K1 and the light intensity ratio A1 are fixed to 1 while performing the OSD display.

(3) The image display device is not limited to the application to the projector 1 for projecting an image, but an application to the device for directly viewing the image displayed on a display surface such as a mobile viewer can also be assumed.

(4) The projector 1 is not limited to the three-panel type using three liquid crystal light valves. The invention can also be applied to, for example, a single-panel projector 1 capable of modulating the R light, the G light, and the B light with a single liquid crystal light valve 40.

(5) Although the transmissive liquid crystal light valves 40 are used as the light modulation device, it is also possible to use a reflective light modulation device such as reflective liquid crystal light valves. Further, it is also possible to use a micromirror array device or the like for modulating the light emitted from the light source by controlling the emission direction of the incident light micromirror by micromirror.

(6) Although the light source 11 is configured including the discharge light source lamp, there can also be used a solid-state light source such as alight emitting diode (LED) or a laser diode, and other light sources.

Further, the device for achieving the system described above can be realized by a single device in some cases, or can also be realized by combining a plurality of devices, and therefore, a variety of configurations are included.

Each of the constituents and combinations of the constituents in the embodiment are illustrative only, and modifications such as addition, omission, or substitution of a constituent can be provided within the scope or the spirit of the invention. Further, the invention is not limited to the embodiment, but is only limited by the appended claims.

What is claimed is:

1. An image display device comprising:
a combining section adapted to generate a composite image obtained by combining an OSD image with a first region of an input image;
a setting section adapted to set a third region in the composite image based on the first region and a second region set at a predetermined position;
a calculation section adapted to calculate a feature amount related to a luminance in the third region; and
an expansion section adapted to expand a grayscale range of the luminance of the composite image based on the feature amount,
wherein the setting section sets the second region as the third region in a case in which the combining section does not combine the OSD image, and sets the third region so as to include the first region and the second region in a case in which the combining section combines the OSD image, and in the case in which at least a part of the first region is located outside the second region.

2. The image display device according to claim 1, wherein
the setting section sets a plurality of regions including the first region and the second region as the third region in a case in which the first region and the second region do not overlap each other.

3. The image display device according to claim 1, further comprising:
a dimming control section adapted to control the luminance of the composite image having been expanded based on the feature amount calculated by the calculation section; and
a display section adapted to display the composite image with the luminance controlled by the dimming control section.

4. The image display device according to claim 1, wherein
the first region and the second region each have a rectangular shape, and
the setting section sets one rectangular region including the first region and the second region as the third region.

5. The image display device according to claim 1, wherein
the setting section sets an entire area of the composite image as the third region in the case in which the combining section combines the OSD image, and in the case in which at least a part of the first region is located outside the second region.

6. An image display device comprising:
a calculation section adapted to calculate a feature amount related to a luminance in a predetermined region of an input image;
an expansion section adapted to perform an expansion process of expanding a grayscale range of the luminance of the input image based on the feature amount; and
a combining section adapted to combine an OSD image with the input image,
wherein the expansion section stops the expansion process in a case in which the combining section combines the OSD image.

7. The image display device according to claim 6, wherein
the combining section combines the OSD image with a first region of the input image,
the calculation section calculates the feature amount in a second region of the input image, and
the expansion section stops the expansion process in a case in which the combining section combines the OSD image, and in the case in which at least a part of the first region is located outside the second region.

8. An image display method comprising:
generating a composite image obtained by combining an OSD image with a first region of an input image;
setting a third region in the composite image based on the first region and a second region set at a predetermined position;
calculating a feature amount related to a luminance in the third region; and
expanding a grayscale range of the luminance of the composite image based on the feature amount,
wherein in the setting, the second region is set as the third region in a case in which the OSD image is not combined in the generating, and the third region is set so as to include the first region and the second region in a case in which the OSD image is combined in the generating, and in the case in which at least a part of the first region is located outside the second region.

9. The image display method according to claim 8, wherein
in the setting, a plurality of regions including the first region and the second region are set as the third region in a case in which the first region and the second region do not overlap each other.

10. The image display method according to claim 8, further comprising:
controlling the luminance of the composite image having been expanded based on the feature amount calculated in the calculating; and
displaying the composite image with the luminance controlled in the controlling.

11. The image display method according to claim 8, wherein
the first region and the second region each have a rectangular shape, and
in the setting, one rectangular region including the first region and the second region is set as the third region.

12. The image display method according to claim 8, wherein
in the setting, an entire area of the composite image is set as the third region in the case in which the OSD image is combined in the generating, and in the case in which at least a part of the first region is located outside the second region.
